(19) United States
(12) Patent Application Publication
(10) Pub. No.: US 2007/0165341 A1
(43) Pub. Date: Jul. 19, 2007

(54) Overvoltage-protective automotive power generation control circuit

(75) Inventor: Chen-Ku Wei, Nantou Country (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/332,350

(22) Filed: Jan. 17, 2006

(51) Int. Cl. H02H 7/06

(52) U.S. Cl. 361/20

(57) ABSTRACT

An overvoltage-protective automotive power generation control circuit that is adapted for electrical connection with a field coil of an automotive power generator includes a voltage detecting circuit electrically connected with a battery-based power source mounted in a car for generating a predetermined partial voltage with respect to the battery-based power source; a driving element having a gate terminal electrically connected with the voltage detecting circuit and two conduction terminals one of which is grounded; and an opening element serially connected with the field coil of the automotive power generator and electrically connected with the other conduction terminal for open circuit upon activation and closed circuit of the driving element. Thus, the battery-based power source is prevented from overcharge and overvoltage to further prevent electronic apparatuses mounted in the car from damage incurred by the overvoltage.

### BACKGROUND OF THE INVENTION

1. Field of the Invention

The present invention relates generally to charging technology of automotive battery, and more particularly, to an overvoltage-protective automotive power generation control circuit.

2. Description of the Related Art

A common car is provided with an automotive battery for supplying each device with electric energy. The car can alternatively include an automotive power generator that keeps charging the automotive battery during the driving course thereof. While the automotive power generator fails, if it fails in full conduction, the voltage of the power in the car will go beyond the default value. If the car runs in high speed, the overvoltage will be higher. The longer it takes, the more likely the electronic apparatuses mounted in the car are burned or damaged.

Since the proportion of electronic apparatuses mounted in the car under the total cost of the car is gradually increased. While the above mentioned power generator fails in full conduction, it causes greater and greater adverse influence. In addition, in the aftermarket of the power generator, if the power generator is of failure to damage the electronic apparatuses, the subsequent reimbursement will be the most troublesome problem.

FIG. 6 illustrates a circuitry of a conventional power generator 60 that includes a field coil 61 electrically connected with a battery-based power source VB via a carbon brush 62, and a semiconductor switch 64, like a power transistor (PTR), electrically connected with a voltage regulator 63. The filed coil 61 is subject to full conduction because the carbon brush 62 is in erroneous contact with a ground terminal.

FIG. 7 illustrates a circuitry of another conventional power generator 70 that includes a field coil 71 grounded via a carbon brush 72, and a semiconductor switch (PTR) 74 electrically connected with a voltage regulator 73. The field coil 71 is subject to full conduction because the carbon brush 72 is in erroneous contact with the power-based power source VB.

Furthermore, while the semiconductor switch fails under the above mentioned two structures, the carbon brush is subject to direct grounding or connection with the battery-based power source to cause full conduction. Therefore, a solution to such problem of failure of the power generator in full conduction is necessary.

### SUMMARY OF THE INVENTION

The primary objective of the present invention is to provide an overvoltage-protective automotive power generation control circuit, which prevents an automotive battery from keeping charged and further from overcharge while the battery is of overvoltage.

The secondary objective of the present invention is to provide an overvoltage-protective automotive power generation control circuit, which prevents automotive electronic apparatuses from damage incurred by overcharging an automotive battery while a power generator fails in full conduction.

The foregoing objectives of the present invention are attained by the overvoltage-protective automotive power generation control circuit that is adapted for electrical connection with a field coil of an automotive power generator. The automotive power generation control circuit includes a voltage detecting circuit, a driving element, and an opening element. The voltage detecting circuit is electrically connected with a battery-based power source mounted in a car for generating a predetermined partial voltage with respect to the battery-based power source. The driving element has a gate terminal and two conduction terminals. The gate terminal is electrically connected with the voltage detecting circuit. One of the two conduction terminals is grounded. The opening element is serially connected with the field coil of the automotive power generator and electrically connected with the other conduction terminal, for open circuit upon activation and closed circuit of the driving element. Thus, the battery-based power source is prevented from overcharge and overvoltage to further prevent the electronic apparatuses mounted in the car from damage incurred by the overvoltage.

### BRIEF DESCRIPTION OF THE DRAWINGS

FIG. 1 is a block diagram of a first preferred embodiment of the present invention.

FIG. 2 shows a circuitry of the first preferred embodiment of the present invention.

FIG. 3 shows another circuitry of the first preferred embodiment of the present invention, showing an alternative location of the opening element.

FIG. 4 shows a circuitry of a second preferred embodiment of the present invention;

FIG. 5 shows another circuitry of the second preferred embodiment of the present invention, showing alternative location of the opening element.

### DETAILED DESCRIPTION OF PREFERRED EMBODIMENTS

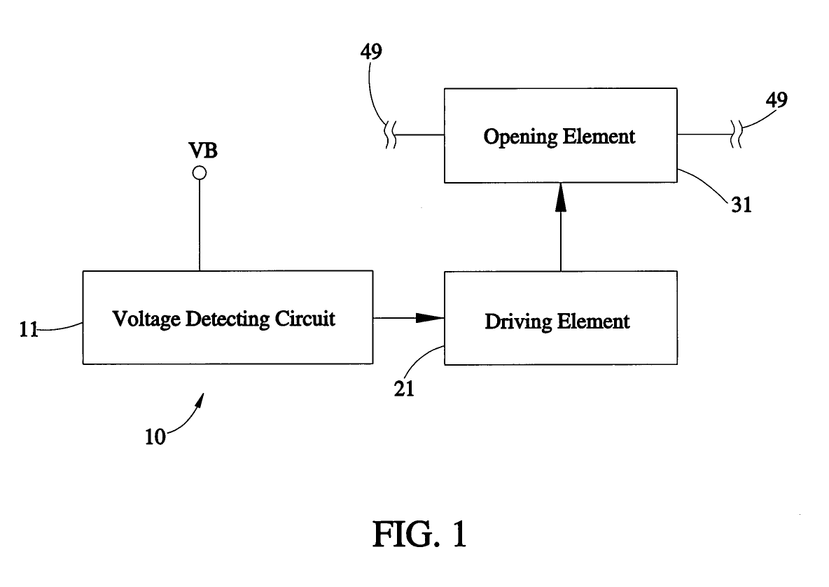

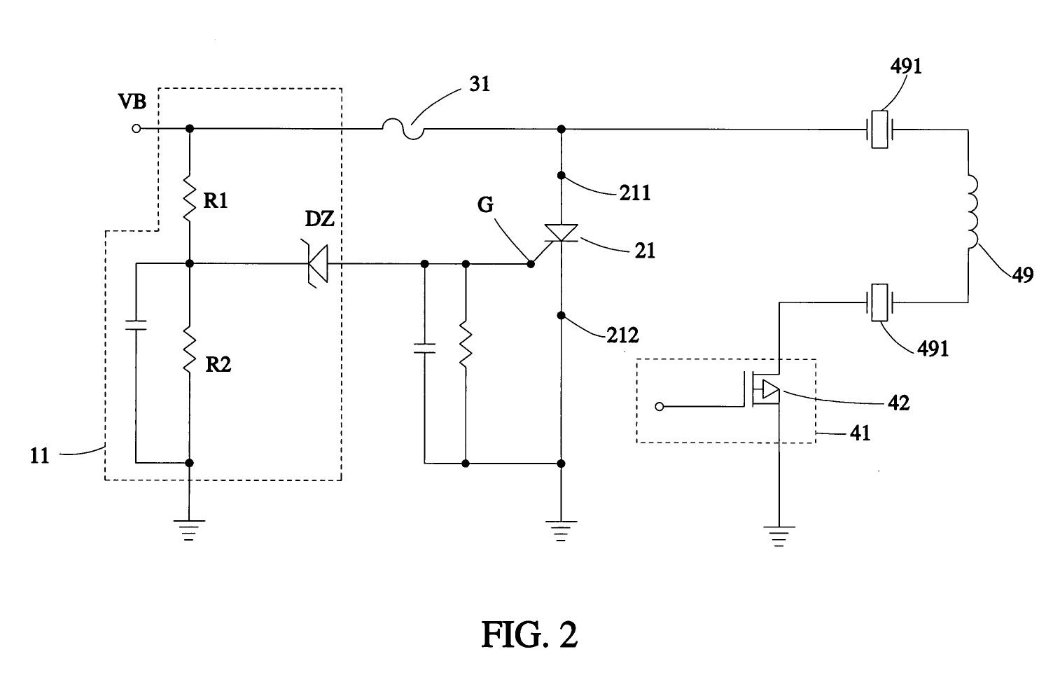

Referring to FIGS. 1-2, an overvoltage-protective automotive power generation control circuit 10 constructed according to a first preferred embodiment of the present invention is adapted for electric connection with a filed coil 49 of an automotive power generator (not shown) via a power regulator 41. The automotive power generation control circuit 10 is composed of a voltage detecting circuit 11, a driving element 21, and an opening element 31.

The voltage detecting circuit 11 includes two resistors R1 and R2 serially connected with each other. The resistor R1 is electrically connected with a battery-based power source VB mounted in a car for generating a predetermined partial voltage with respect to the battery-based power source VB, and is electrically connected with a Zener diode DZ at a voltage-dividing point that the two resistors R1 and R2 butts. The voltage detecting circuit 11, which is an independent circuit in this embodiment, can be directly integrated into the voltage regulator 41 during actual production. Since such integration of the voltage detecting circuit 11 and the voltage regulator 41 can be easily done by people of ordinary skill in the art, no further recitation is necessary.

The driving element 21 which is a power semiconductor element, such as a silicon-controlled rectifier (SCR), having a gate terminal G and two conduction terminals 211 and 212. The gate terminal is electrically connected with the Zener diode DZ of the voltage detecting circuit 11. The two conduction terminals 211 and 212 are electrically connected with the opening element 31 and grounded respectively.

The opening element 31, which is a fuse in this embodiment, is serially connected via a carbon brush 491 with the field coil 49 of the automotive power generator (not shown), for open circuit caused by introduction of overcharge upon activation and closed circuit of the driving element 21.

The field coil 49 is electrically connected via another carbon brush 491 with the voltage regulator 41 which has a semiconductor switch 42. The semiconductor switch 42 can alternatively be a PTR or a metal oxide semiconductor field-effect transistor (MOSFET). The voltage regulator 41 is electrically connected with the filed coil 49 of the power generator (not shown) and can be driven for conduction to enable electric current to flow through the filed coil 49 for power generation.

Referring to FIG. 2, the field coil 49, under normal condition of the voltage of the battery-based power source VB, is controlled by the voltage regulator 41 for power generation. While the voltage of the battery-based power source VB is preferably high; for example, the battery-based powers source VB is overcharged to generate overvoltage while the semiconductor switch 42 is damaged and the carbon brush 491 is grounded to cause full conduction; the partial voltage between the two resistors R1 and R2 is enhanced to cause breakdown of the Zener diode DZ and to further trigger conduction of the driving element 21. In the meantime, the battery-based power source VB and the ground are located at two ends of the opening element 31 and the electric current of the battery-based power source VB directly flows through the opening element 31 to burn out the opening element 31, thus preventing the electric energy generated by the field coil 49 from recharging a battery (not shown) of the battery-based power source VB.

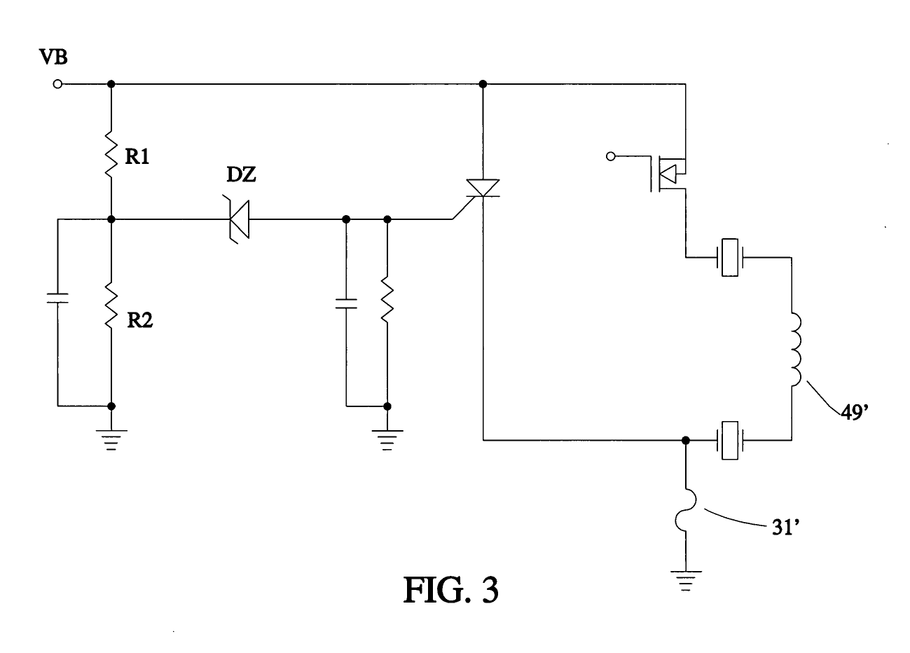

Referring to FIG. 3, the opening element 31′ can be alternatively located between the ground terminal and the field coil 49′ to achieve the same effect as the structure indicated in FIG. 2. (While the semiconductor switch 42 is damaged and the carbon brush 491 is grounded to cause full conduction.) The opening element 31 can alternatively be a recoverable fuse which causes open circuit while a current flows therethrough.

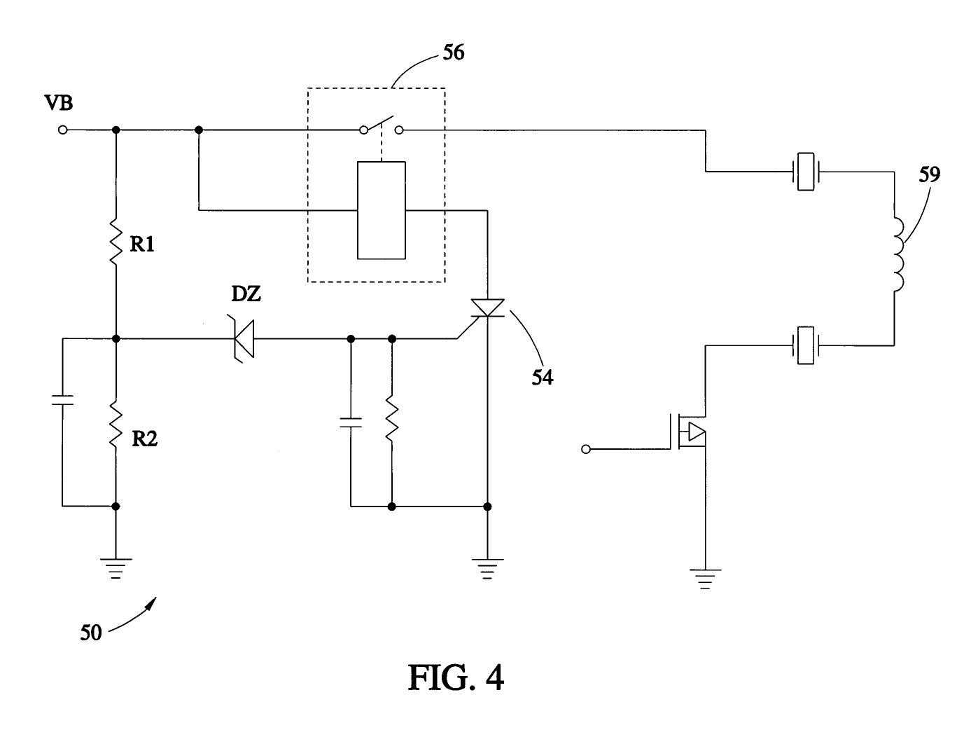

Referring to FIG. 4, an overvoltage-protective automotive power generation control circuit 50 constructed according to a second preferred embodiment of the present invention is similar to the first embodiment, having difference recited below.

The opening element 56 is a relay. The driving element 54 is an SCR for latching the opening element 56 and further enabling open circuit of the opening element 56, thus breaking off the overcharge incurred by the field coil 59 to the battery (not shown) of the battery-based power source VB.

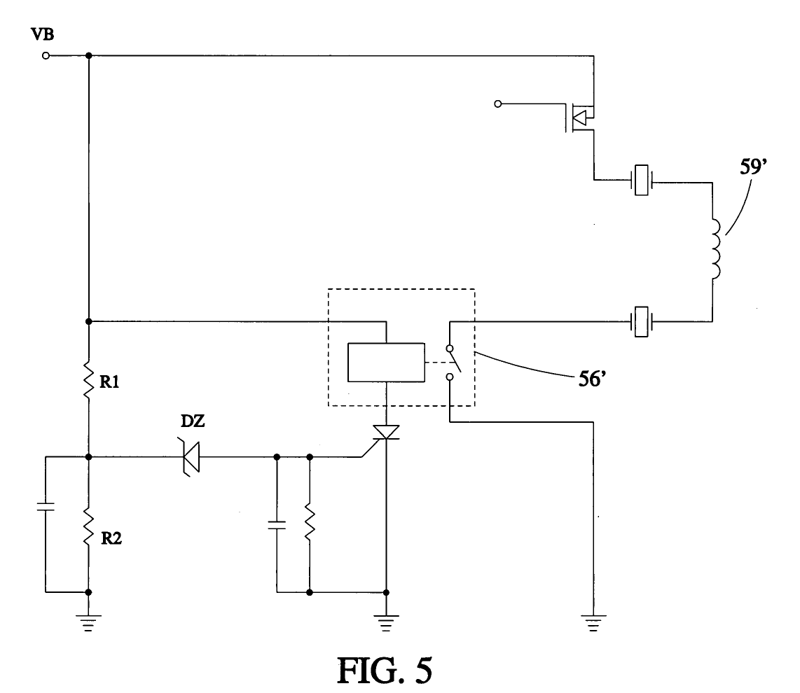

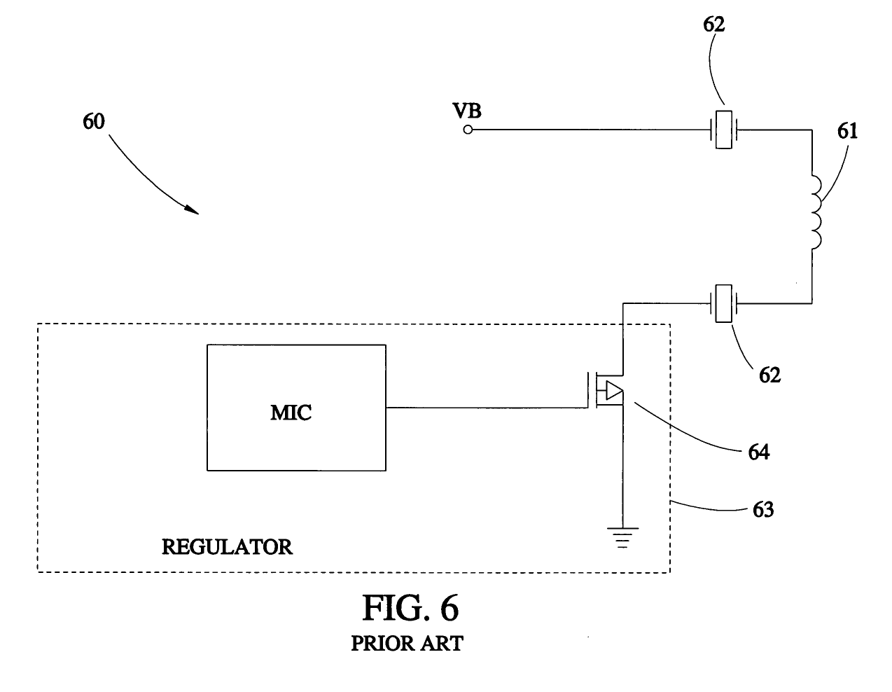

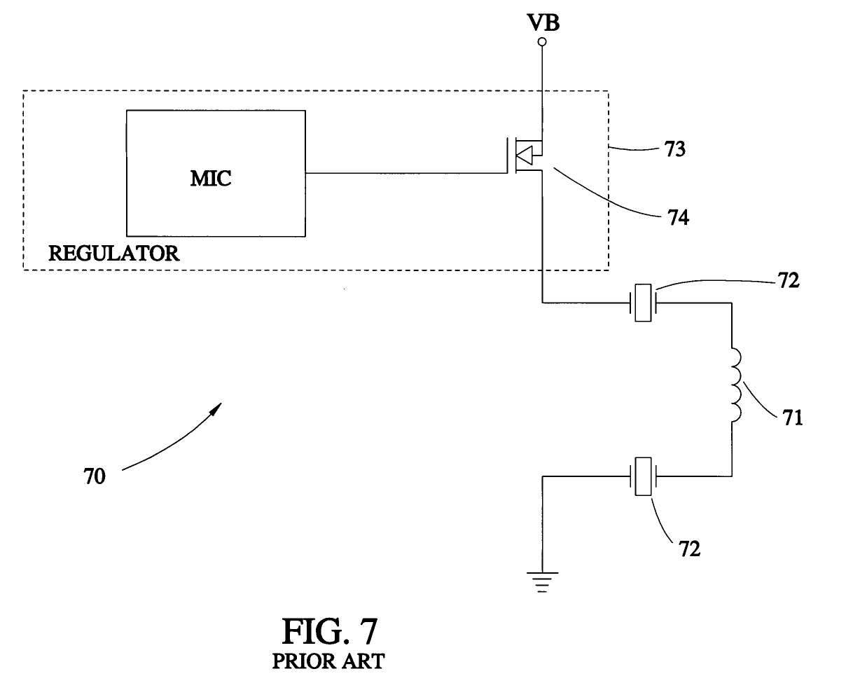

Referring to FIG. 5, in a second preferred embodiment of the present invention, the opening element 56′ can be alternatively located between the ground terminal and the field coil 59′ to achieve the same effect as the structure indicated in FIG. 4.

In conclusion, the present invention includes advantages as follows.
1. Prevention of overcharge to the automotive battery: The present invention can effectively prevent the battery with overvoltage from keeping charged and overcharge.
2. Avoidance of damage to the automotive electronic apparatuses: The present invention can avoid the automotive power generator failing in full conduction from overcharging the battery and then damaging other electronic apparatuses.

What is claimed is:

1. An overvoltage-protective automotive power generation control circuit adapted for electrical connection with a field coil of an automotive power generator, comprising:
a voltage detecting circuit connected with an automotive battery-based power source for generating a predetermined partial voltage with respect to said battery-based power source;
a driving element having a gate terminal and two conduction terminals, said gate terminal being connected with said voltage detecting circuit, one of said two conduction terminals being grounded; and
an opening element serially connected with said field coil of said power generator and connected with the other conduction terminal, for open circuit upon activation of said driving element.

2. The overvoltage-protective automotive power generation control circuit as defined in claim 1, wherein said voltage detecting circuit further comprises a Zener diode connected with said gate terminal of said driving element.

3. The overvoltage-protective automotive power generation control circuit as defined in claim 2, wherein said voltage detecting circuit is an independent circuit or integrated into a voltage regulator having a semiconductor switch, said voltage regulator being connected with said field coil of said power generator for conduction driven to enable electric current to flow through said field coil for power generation.

4. The overvoltage-protective automotive power generation control circuit as defined in claim 1, wherein said opening element is a fuse, a recoverable fuse, or a relay.

5. The overvoltage-protective automotive power generation control circuit as defined in claim 4, wherein said driving element is a power semiconductor for latching said opening element defined as a relay.

6. The overvoltage-protective automotive power generation control circuit as defined in claim 5, wherein said power semiconductor is a silicon-controlled rectifier (SCR).

7. The overvoltage-protective automotive power generation control circuit as defined in claim 1, wherein said voltage detecting circuit includes two resistors serially connected with each other, one of said two resistors being connected with said battery-based power source.

8. The overvoltage-protective automotive power generation control circuit as defined in claim 1, wherein said opening element is caused for open circuit by introduction of overcharge upon closed circuit of said driving element.
